(19) United States
(12) Patent Application Publication
(10) Pub. No.: US 2026/0001344 A1
(43) Pub. Date: Jan. 1, 2026

(54) LIQUID DISCHARGE HEAD AND PRODUCTION METHOD OF LIQUID DISCHARGE HEAD

(71) Applicant: CANON KABUSHIKI KAISHA, Tokyo (JP)

(72) Inventor: RYOTARO MURAKAMI, Kanagawa (JP)

(21) Appl. No.: 19/243,285

(22) Filed: Jun. 19, 2025

(30) Foreign Application Priority Data
Jun. 28, 2024 (JP) 2024-105242

(51) Int. Cl. B41J 2/18; B41J 2/14; B41J 2/16; B41J 2/175

(52) U.S. Cl. CPC B41J 2/18; B41J 2/14016; B41J 2/14201; B41J 2/1601; B41J 2/1623; B41J 2/1629; B41J 2/1634; B41J 2/1648; B41J 2/17596; B41J 2002/14306

(57) ABSTRACT

A liquid discharge head includes a discharge element substrate and an opening diameter conversion plate. The discharge element substrate and the opening diameter conversion plate are laminated in a first direction. A second opening width is larger than a first opening width in a second direction orthogonal to the first direction. A supply connection flow path configured to connect a first opening and a second opening is formed in the opening diameter conversion plate. A wall surface of the supply connection flow path includes an inclined portion inclining with respect to the first direction.

### BACKGROUND

### Field of the Technology

The present disclosure relates to a liquid discharge head and a production method of the liquid discharge head.

### Description of the Related Art

A liquid discharge apparatus is mounted with a liquid discharge head for discharging liquid to achieve a desired purpose by discharging liquid. For example, an inkjet recording apparatus is mounted with an inkjet recording head serving as a liquid discharge head on a carriage to record images, characters, and the like on a recording medium, by discharging ink from a discharge element substrate included in the ink jet recording head. The liquid discharged from the discharge element substrate is supplied from a liquid reservoir provided on the liquid discharge apparatus or the liquid discharge head. The liquid supplied from the liquid reservoir is supplied through a large diameter flow path, but since the discharge element substrate has a minute flow path structure, it is necessary to concentrate the liquid from the large diameter flow path to the minute discharge element substrate.

Japanese Patent Application Laid-open No. 2020-142533 discusses a liquid discharge head including an opening diameter conversion plate for converting an opening diameter from a large-diameter flow path to a flow path of a minute discharge element substrate. The opening diameter conversion plate has a first opening connecting to the discharge element substrate, a second opening for supplying liquid to the opening diameter conversion plate, and a connection flow path connecting the first opening and the second opening. The opening width of the second opening is configured to be larger than that of the first opening.

### SUMMARY

The liquid in the discharge element substrate can be concentrated due to the evaporation because a discharge port of the discharge element substrate is exposed to the external air. When the concentration progresses, there is a concern that discharge failure may occur. Since the opening diameter conversion plate is directly connected with the discharge element substrate, i.e., the opening diameter conversion plate is located near the discharge port, the connection flow path that connects the second opening and the first opening is required to have a shape that makes it difficult for the liquid to concentrate.

However, the opening diameter conversion plate discussed in Japanese Patent Application Laid-open No. 2020-142533 has a configuration in which the wall surface of the connection flow path that connects the second opening and the first opening is bent with no inclined portion. Accordingly, the liquid tends to accumulate at the bending portion, and there is a possibility of concentration and fixation of the liquid.

The present disclosure is directed to a liquid discharge head capable of suppressing concentration and fixation of liquid in a flow path formed in an opening diameter conversion plate, and a production method of the liquid discharge head.

According to some embodiments, a liquid discharge head includes a discharge element substrate having a first surface and a second surface that is a rear surface of the first surface, in which a discharge port configured to discharge liquid is formed on a first surface side and a supply opening configured to supply the liquid to the discharge port is formed on a second surface side, and an opening diameter conversion plate having a third surface and a fourth surface that is a rear surface of the third surface, in which a first opening having a first opening width and connected with the supply opening is formed on a third surface side and a second opening having a second opening width and communicating with the first opening is formed on a fourth surface side, wherein the discharge element substrate and the opening diameter conversion plate are laminated in a first direction, wherein the second opening width is larger than the first opening width in a second direction orthogonal to the first direction, wherein a supply connection flow path configured to connect the first opening and the second opening is formed in the opening diameter conversion plate, and wherein a wall surface of the supply connection flow path includes an inclined portion inclining with respect to the first direction.

Features of the present disclosure will become apparent from the following description of embodiments with reference to the attached drawings. The following description of embodiments are described by way of example.

### BRIEF DESCRIPTION OF THE DRAWINGS

FIG. 1 is an exploded perspective diagram of a liquid discharge head.

FIG. 2 is a schematic cross-section diagram of the liquid discharge head.

FIG. 3 is a schematic exploded cross-section diagram of the liquid discharge head.

FIG. 4 is a cross-section diagram of a supply connection flow path.

FIG. 5A is a cross-section diagram of a silicon substrate. FIG. 5B is a cross-section diagram of the silicon substrate with photoresist formed thereon. FIG. 5C is a cross-section diagram of the silicon substrate with a second opening formed therein.

FIG. 5D is a cross-section diagram of the silicon substrate in an upside-down state of the silicon substrate in FIG. 5C. FIG. 5E is a cross-section diagram of the silicon substrate with a first opening formed therein. FIG. 5F is a cross-section diagram of the silicon substrate with the photoresist removed therefrom. FIG. 5G is a cross-section diagram of the silicon substrate with the first opening and the second opening communicating with each other.

### DESCRIPTION OF THE EMBODIMENTS

Hereinbelow, various exemplary embodiments, features, and aspects of the present disclosure will be described with reference to the attached drawings. The exemplary embodiments described below are not intended to limit the range of the present disclosure, and not all the combinations of the features described in the exemplary embodiments are necessarily essential for the solution of the present disclosure. In addition, the same reference numbers are assigned to the same components.

A liquid discharge head according to the present exemplary embodiment is an inkjet head that discharges ink, but it is not limited thereto as long as the liquid discharge head discharges liquid. Since the ink is easily fixed in an opening diameter conversion member, the present disclosure is desirable for the inkjet head.

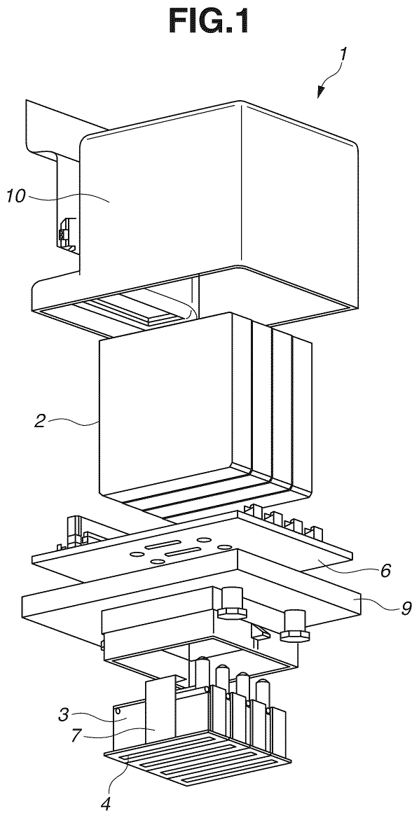

FIG. 1 illustrates an exploded perspective diagram of a liquid discharge head 1 according to the present exemplary embodiment. The liquid discharge head 1 includes a flow path unit 3 provided with a discharge element substrate 4. The detailed configuration of the discharge element substrate 4 will be described below. The flow path unit 3 is a unit in which flow paths for supplying liquid to the discharge element substrate 4 are unitized.

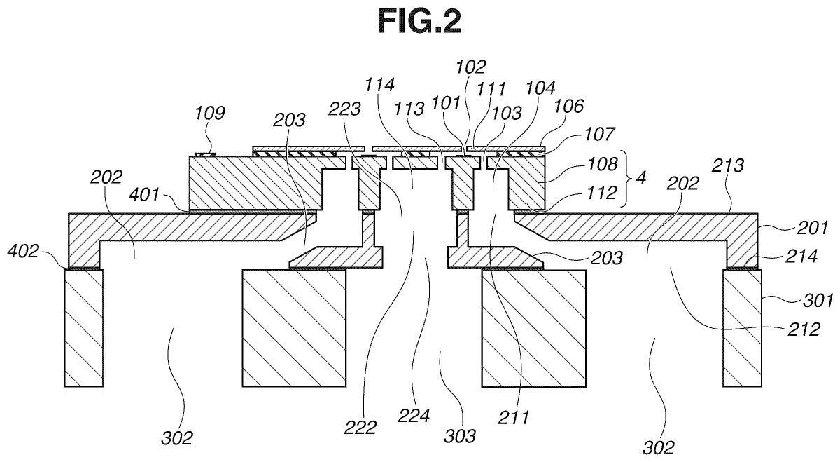

The liquid discharge head 1 includes a circulation unit 2 for circulating liquid inside the liquid discharge head 1. The circulation unit 2 desirably include a circulation pump (not illustrated) for circulating the liquid, or a pressure adjustment unit (not illustrated) for adjusting pressure inside the liquid discharge head 1. The liquid discharge head 1 according to the present exemplary embodiment includes the circulation unit 2, but may not include the circulation unit 2. In a case where the liquid discharge head 1 includes the circulation unit 2, the accumulation of the liquid in an opening diameter conversion plate 201 (see FIG. 2) is suppressed, and thus it is more desirable. The circulation pump is desirably a small size diaphragm pump, but can be a tube pump other than the diaphragm pump.

The liquid discharge head 1 includes an electric wiring member 6 for driving the circulation pump provided in the circulation unit 2. The electric wiring member 6 is electrically connected to a liquid discharge apparatus main body (not illustrated) to supply power to the circulation pump. The electric wiring member 6 also performs function of supplying power via a flexible wiring board 7 to a discharge element 101 (see FIG. 2) provided on the discharge element substrate 4.

The components of the liquid discharge head 1 described above are covered by a frame 9 and a case 10. The liquid discharge head 1 according to the present exemplary embodiment is a so-called serial head that is mounted on a carriage of the liquid discharge apparatus (not illustrated), and relatively moves to a recording medium to which liquid is discharged from the liquid discharge head 1. The liquid discharge head 1 can also be a so-called full-line head in which a plurality of the discharge element substrates 4 is arranged in line with respect to the recording medium.

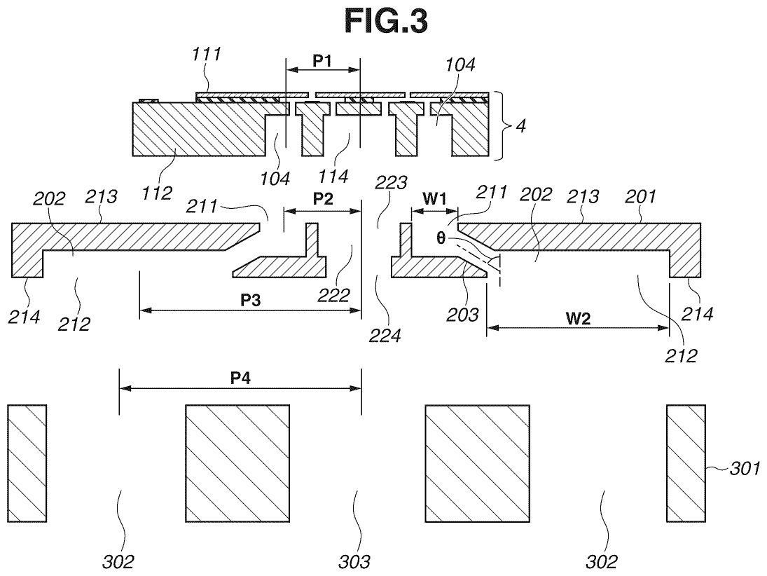

FIG. 2 is a schematic cross-section diagram of the liquid discharge head 1, and FIG. 3 is an exploded cross-section diagram of the liquid discharge head 1. The discharge element substrate 4 is formed by laminating a discharge port forming substrate 106, a pressure chamber forming substrate 107, and a flow path forming substrate 108.

In the discharge port forming substrate 106, a discharge port 102 for discharging liquid is formed. The material of the discharge port forming substrate 106 is not specifically limited, and an inorganic material such as a photosensitive resin composition and Steel Use Stainless (SUS) can be used. In the flow path forming substrate 108, a supply flow path 104 (also referred to as a supply opening) for supplying liquid to the discharge port 102 is formed. The flow path forming substrate 108 is also provided with the discharge element 101 for generating pressure to discharge liquid through the discharge port 102. The discharge element 101 can be of a thermal method of generating pressure for discharging liquid using a thermoelectric transducer, or of a piezoelectric method of generating pressure for discharging liquid using a piezoelectric element. The discharge element 101 can also be of any one of various kinds of other liquid discharge methods. Electric power is supplied to the discharge element 101 through a wiring line 109. The material of the flow path forming substrate 108 is not specifically limited, but it is desirably made of silicon. The flow path can be formed with high precision when the flow path forming substrate 108 is made of silicon. In the pressure chamber forming substrate 107, a pressure chamber for the pressure generated by the discharge element 101 to act on the liquid is formed. The materials of the pressure chamber forming substrate 107 and the discharge port forming substrate 106 are not specifically limited, but are desirably formed of a photosensitive resin composition.

As described above, the discharge element substrate 4 includes a first surface 111 (front surface of the discharge port forming substrate 106), and a second surface 112 (rear surface of the flow path forming substrate 108), which is the surface opposite to the first surface 111.

Further, the discharge port 102 is formed on the first surface 111 side, and the supply flow path 104 is formed on the second surface 112 side.

The liquid discharge head 1 according to the present exemplary embodiment is a circulation head in which liquid circulates. The circulation head has a merit of being able to easily suppress the accumulation and the fixation of the liquid in the flow path, because a recovery flow path (also referred to as a recovery opening) for recovering the liquid supplied through a supply port and not discharged through the discharge port 102 is formed to keep the liquid circulating.

In the liquid discharge head 1 according to the present exemplary embodiment, the liquid that has flowed through the supply flow path 104 is supplied to a plurality of supply flow paths 103. The liquid is then supplied from a plurality of the supply flow paths 103 to a plurality of the corresponding discharge ports 102. Thus, the supply flow path 104 is a so-called common supply flow path, and the supply flow paths 103 are so-called individual supply flow paths. Hereinbelow, the supply flow path 104 is referred to as the common supply flow path 104, and the supply flow paths 103 are referred to as the individual supply flow paths 103. The liquid discharge head 1 according to the present exemplary embodiment also includes recovery flow paths 113 and a recovery flow path 114 for recovering the liquid not discharged through the discharge port 102. The recovery flow paths 113 are so-called individual recovery flow paths for recovering liquid from a plurality of the corresponding discharge ports 102, and the recovery flow path 114 is a so-called common recovery flow path for recovering the liquid from a plurality of the individual recovery flow paths 113. As described above, the liquid discharge head 1 according to the present exemplary embodiment includes the supply paths and the recovery flow paths, and it is thereby possible to suppress the accumulation and the fixation of the liquid in the flow paths.

The individual supply flow paths 103 and the common supply flow path 104 can be formed by a bosch process, which is a type of reactive ion etching, or an anisotropic etching using tetramethyl ammonium hydroxide (TMAH) or potassium hydroxide (KOH). The bosch process is a method of forming an etching groove perpendicular to a substrate by alternately performing a protection of a wall surface, and an etching. A method of forming a non-through hole and making the substrate thinner to penetrate the substrate by using back grinding or chemical mechanical polishing (CMP) can also be employed.

The liquid supplied from the liquid reservoir (not illustrated) to the discharge element substrate 4 flows through a large-diameter flow path, but the discharge element substrate 4 has a minute flow path structure, and thus the liquid needs to be directed to the minute discharge element substrate 4.

For this reason, the liquid discharge head 1 according to the present exemplary embodiment has the opening diameter conversion plate 201.

The discharge element substrate 4 and the opening diameter conversion plate 201 are laminated in a first direction (lamination direction). The opening diameter conversion plate 201 has a third surface 213 and a fourth surface 214, which is a rear (opposite) surface of the third surface 213. A first opening 211 having a first opening width W1 and communicating with the supply flow path 104 is formed on the third surface 213 side. A second opening 212 having a second opening width W2 and communicating with the first opening 211 is formed on the fourth surface 214 side. In a second direction orthogonal to a lamination direction of the discharge element substrate 4 and the opening diameter conversion plate 201, a second opening width W2 is larger than the first opening width W1. Thus, the opening diameter conversion plate 201 performs function of concentrating the liquid from the large-diameter flow path to the minute discharge element substrate 4.

Since the opening diameter conversion plate 201 is directly connected with the discharge element substrate 4, i.e., the opening diameter conversion plate 201 is located near the discharge element substrate 4, the accumulation of the liquid in the flow paths in the opening diameter conversion plate 201 becomes an issue.

In the opening diameter conversion plate 201 according to the present exemplary embodiment, the first opening 211 and a second opening 212 are connected by a supply connection flow path 202, and the wall surface of the supply connection flow path 202 includes an inclined portion 203 inclining with respect to the first direction (lamination direction), accordingly. In this way, since the number of bending portions of the flow paths inside the opening diameter conversion plate 201 reduces, it is possible to suppress the condensation and the fixation of the liquid in the flow paths formed inside the opening diameter conversion plate 201. The flow direction of the liquid flowing through the supply connection flow path 202 is also inclined with respect to the first direction (lamination direction). In this way, the liquid flows easily to a corner of each of the flow paths formed inside the opening diameter conversion plate 201, and it is possible to reduce the possibility of the accumulation of the liquid.

The first opening 211 and the second opening 212 do not desirably overlap when viewed from the first direction (lamination direction). With this configuration, it becomes easier to concentrate the liquid that has flowed from the liquid reservoir through the large-diameter flow path to the minute discharge element substrate 4.

It is desirable that an inclination angle θ inclining with respect to the first direction of the inclined portion 203 is 55° or more and 80° or less. The inclination angle within this range allows the liquid flowing through the supply connection flow path 202 to easily flow to the corner portion of the flow path. The wall surface facing the inclined portion 203 among the wall surfaces of the supply connection flow path 202 can also be a perpendicular surface.

Between the discharge element substrate 4 and the opening diameter conversion plate 201, various kinds of films can also be formed.

The liquid discharge head 1 according to the present exemplary embodiment is a liquid discharge head in which liquid circulates, and thus a configuration for recovering the liquid is also formed in the opening diameter conversion plate 201. A third opening 223 and a fourth opening (recovery port) 224 are formed in the opening diameter conversion plate 201. The third opening 223 is connected to the common recovery flow path 114 and formed on the third surface 213 side, and the fourth opening 224 communicates with the third opening 223 and is formed on the fourth surface 214 side. The third opening 223 and the fourth opening 224 are connected by a recovery connection flow path 222. The opening width of the third opening 223 and the opening width of the fourth opening 224 are not specifically limited. The wall surface of the recovery connection flow path 222 can also not have the inclined portion.

A support substrate 301 is joined to support the discharge element substrate 4 and the opening diameter conversion plate 201 on the fourth surface 214 side of the opening diameter conversion plate 201. The support substrate 301 is formed with supply through-holes 302 for connecting to the second opening 212 of the opening diameter conversion plate 201 to supply liquid, and a recovery through-hole 303 connecting to the fourth opening 224 to recover the liquid.

The liquid discharge head 1 has the flow path configuration described above, and the liquid circulates through the supply through-hole, the supply connection flow path, the supply opening 104, the recovery opening, the recovery connection flow path, and the recovery through-hole, in this order. The discharge element substrate 4 and the opening diameter conversion plate 201 are joined by an adhesive layer 401, and the opening diameter conversion plate 201 and the support substrate 301 are joined by an adhesive layer 402. A close contact film or the like can also be formed between the discharge element substrate 4 and the opening diameter conversion plate 201, and between the opening diameter conversion plate 201 and the support substrate 301.

P1 is desirably 0.6 mm or less, where P1 is a pitch between the adjacent common supply flow path 104 and the common recovery flow path 114 in the second direction orthogonal to the first direction (lamination direction). The size of the discharge element substrate 4 can be made smaller as P1 is smaller, and the cost can be reduced.

When P1>P2 is satisfied, where P2 is the distance between the center of the first opening 211 and the center of the third opening 223 in the second direction orthogonal to the first direction (lamination direction), a corner portion of the flow path of the common supply flow path 104 or the common recovery flow path 114 on the opening diameter conversion plate 201 side is formed, and the liquid tends to accumulate. P1≤P2 is thus desirably satisfied.

P3 is desirably 3.0 mm or more, where P3 is the distance between the center of the second opening 212 and the center of the fourth opening 224 in the second direction orthogonal to the first direction (lamination direction).

When P3>P4 is satisfied, where P4 is the distance between the center of the supply through-hole 302 and the center of the recovery through-hole 303 in the second direction orthogonal to the first direction (lamination direction), a corner portion is formed near the fourth opening 224 of the opening diameter conversion plate 201, and the liquid tends to accumulate. Thus, P3≤P4 is desirably satisfied.

P2<P3 is desirably satisfied from the viewpoint of concentrating the liquid to the discharge element substrate 4 by the opening diameter conversion plate 201.

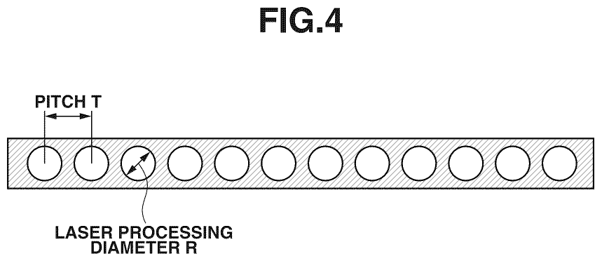

The opening diameter conversion plate 201 is desirably made of silicon. A substrate with a crystal plane (100) or (110) surface can be selected as the silicon substrate. In particular, in a case where wet etching processing by an alkali aqueous solution is performed using a substrate with the crystal plane (110), the wall surfaces of the supply connection flow path 202 and the recovery connection flow path 222 can easily be formed in a vertical manner. The supply connection flow paths 202 each including the inclined portion 203 can also be continuously formed, by irradiating the inclined portion 203 with a laser by a laser processing apparatus employing a yttrium aluminum garnet (YAG) laser, and processing such that T<R/2 is satisfied where R is the processing diameter of the laser processing unit and T is the processing pitch. As illustrated in the cross-section diagram of the supply connection flow path 202 in FIG. 4, the supply connection flow paths 202 can also be discontinuously formed by performing processing so as to satisfy T<2R where R is the processing diameter, and T is the processing pitch. In a case where the supply connection flow paths 202 are discontinuously formed, the rigidity of the opening diameter conversion plate 201 can be increased compared with the case where the supply connection flow paths 202 are continuously formed. It is also possible to remove the silicon debris generated in the laser processing, and to smoothen the processed surface by performing etching using alkaline aqueous solution such as a tetramethylammonium hydroxide (TMAH) aqueous solution and a kalium hydroxide (KOH) aqueous solution after the laser processing.

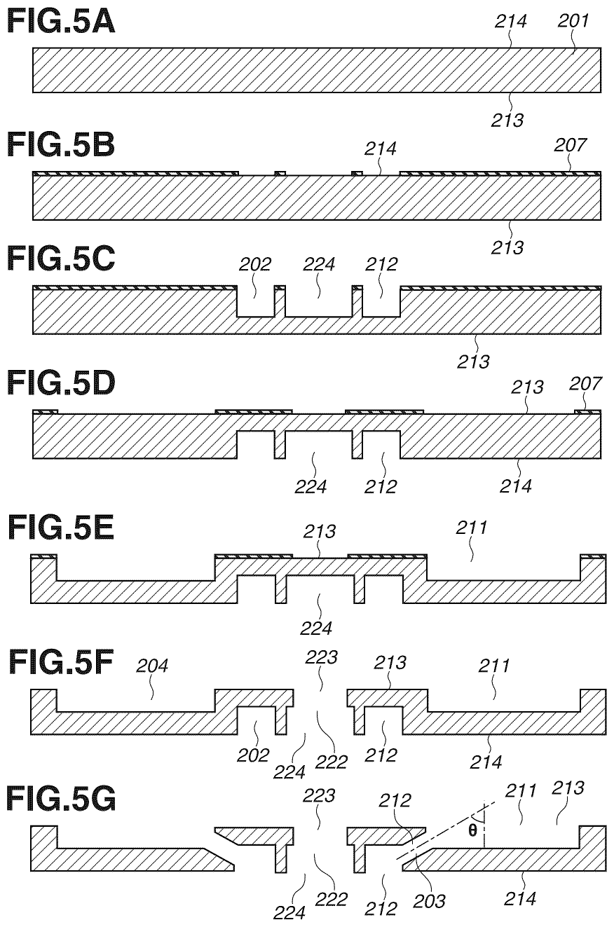

Next, a production method of the opening diameter conversion plate 201 according to the present exemplary embodiment will be described with reference to FIGS. 5A to 5G. First, as illustrated in FIG. 5A, a silicon substrate (opening diameter conversion plate 201) with a thickness of 0.725 mm was prepared. Next, as illustrated in FIG. 5B, a photoresist 207 was formed on the fourth surface 214 of the silicon substrate, and was patterned in an area in which the second opening 212 of the fourth surface 214 was to be formed and in an area in which the fourth opening 224 was to be formed. Next, as illustrated in FIG. 5C, a non-through hole including the second opening 212 and a non-through hole including the fourth opening 224 were formed by a dry etching of a bosch process each to a depth of 400 μm (micrometers). In a similar manner, as illustrated in FIG. 5D, a non-through hole including the first opening 211 was formed in the silicon substrate on the third surface 213 side to a depth of 400 μm. In this case, the third opening 223 and the fourth opening 224 communicated with each other by the recovery connection flow path 222, by forming a through-hole including the third opening 223. In the process in FIG. 5D, the silicon substrate was reversed upside down from the state in FIG. 5C. Next, as illustrated in FIG. 5E, the photoresist 207 formed on the silicon substrate was removed. Next, as illustrated in FIG. 5F, laser processing was performed such that the non-through hole including the first opening 211 and the non-through hole including the second opening 212 were communicated with each other as illustrated in FIG. 5G. At this time, the laser processing was performed such that the inclination angle θ became 75° with respect to the first direction (lamination direction). In addition, P1 and P2 were set to 0.6 mm, P3 was set to 3.0 mm, P4 was set to 3.3 mm, W1 was set to 0.25 mm, and W2 was set to 1.8 mm.

The opening diameter conversion plate 201 produced in the processes described above was laminated with the discharge element substrate 4 and the support substrate 301, to produce the liquid discharge head 1 illustrated in FIG. 1. The liquid discharge head 1 produced in this way was able to reduce the accumulation, the condensation, and the fixation of the liquid inside the opening diameter conversion plate 201 by including the inclined portion 203 inside the opening diameter conversion plate 201.

According to the present disclosure, it is possible to provide a liquid discharge head capable of reducing fixation of liquid in a flow path formed inside an opening diameter conversion plate, and a production method of the liquid discharge head.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2024-105242, filed Jun. 28, 2024, which is hereby incorporated by reference herein in its entirety.

What is claimed is:

1. A liquid discharge head comprising:
a discharge element substrate having a first surface and a second surface that is a rear surface of the first surface, in which a discharge port configured to discharge liquid is formed on a first surface side and a supply opening configured to supply the liquid to the discharge port is formed on a second surface side; and
an opening diameter conversion plate having a third surface and a fourth surface that is a rear surface of the third surface, in which a first opening having a first opening width and connected with the supply opening is formed on a third surface side and a second opening having a second opening width and communicating with the first opening is formed on a fourth surface side,
wherein the discharge element substrate and the opening diameter conversion plate are laminated in a first direction,
wherein the second opening width is larger than the first opening width in a second direction orthogonal to the first direction,
wherein a supply connection flow path configured to connect the first opening and the second opening is formed in the opening diameter conversion plate, and
wherein a wall surface of the supply connection flow path includes an inclined portion inclining with respect to the first direction.

2. The liquid discharge head according to claim 1, wherein a flow direction of liquid flowing in the supply connection flow path inclines with respect to the first direction.

3. The liquid discharge head according to claim 1, wherein an inclination angle of the inclined portion with respect to the first direction is 55° or more and 80° or less.

4. The liquid discharge head according to claim 1, wherein the first opening and the second opening do not overlap with each other, when viewed from the first direction.

5. The liquid discharge head according to claim 1, wherein the opening diameter conversion plate is made of silicon.

6. The liquid discharge head according to claim 1,
wherein the discharge element substrate has a recovery opening configured to recover liquid that has not discharged from the discharge port, and
wherein the opening diameter conversion plate is provided with a third opening connected to the recovery opening and formed on the third surface, a fourth opening communicating with the third opening and formed on the fourth surface, and a recovery connection flow path connecting the third opening and the fourth opening.

7. The liquid discharge head according to claim 6, wherein the liquid circulates through the supply connection flow path, the supply opening, the recovery opening, and the recovery connection flow path in this order.

8. The liquid discharge head according to claim 7, wherein P1 is 0.6 mm (millimeter) or less, where P1 is a distance, in the second direction, between a center of the supply opening and a center of the recovery opening.

9. The liquid discharge head according to claim 8, wherein P1≤P2 is satisfied, where P2 is a distance, in the second direction, between a center of the first opening and a center of the third opening.

10. The liquid discharge head according to claim 9, wherein P3 is 3.0 mm or more, where P3 is a distance, in the second direction, between a center of the second opening and a center of the fourth opening.

11. The liquid discharge head according to claim 10, further comprising a support substrate in which a supply through-hole configured to supply liquid to the second opening and a recovery through-hole configured to recover the liquid from the fourth opening are formed, and configured to support the discharge element substrate and the opening diameter conversion plate,
wherein the support substrate is joined to the fourth surface of the opening diameter conversion plate such that the second opening and the supply through-hole are connected with each other and the fourth opening and the recovery through-hole are connected with each other, and
wherein P3≤P4 is satisfied, where P4 is a distance, in the second direction, between a center of the supply through-hole and a center of the recovery through-hole.

12. The liquid discharge head according to claim 11, wherein P2<P3 is satisfied.

13. The liquid discharge head according to claim 7, further comprising a circulation pump configured to circulate the liquid.

14. A production method of a liquid discharge head including a discharge element substrate in which a discharge port configured to discharge liquid and a supply opening configured to supply the liquid to the discharge port are formed, and an opening diameter conversion plate in which a first opening having a first opening width and connected to the supply opening, and a second opening having a second opening width and connected to the first opening are formed, wherein the discharge element substrate and the opening diameter conversion plate are laminated in a first direction, and wherein the second opening width is larger than the first opening width in a second direction orthogonal to the first direction, the production method comprising:
forming the first opening and the second opening by etching; and
forming a supply connection flow path configured to connect the first opening and the second opening, by making the first opening and the second opening communicate with each other by laser processing,
wherein the supply connection flow path includes an inclined portion inclining with respect to the first direction.

15. The production method of the liquid discharge head according to claim 14, wherein the opening diameter conversion plate is made of silicon.

16. The production method of the liquid discharge head according to claim 14, wherein the etching is a reactive ion etching or an alkali aqueous solution wet etching.

17. The production method of the liquid discharge head according to claim 16, wherein the alkaline aqueous solution is a tetramethylammonium hydroxide aqueous solution or a kalium hydroxide aqueous solution.
